(19) United States
(12) Patent Application Publication
(10) Pub. No.: US 2009/0273673 A1
(43) Pub. Date: Nov. 5, 2009

(54) PERSONAL VEHICLE SURVEILLANCE SYSTEM

(76) Inventors: John R. Worley, III, Durham, NC (US); Jerome Otto Worley, Tukwila, WA (US)

Correspondence Address: PASSE' INTELLECTUAL PROPERTY, LLC, 1717 BRASSFIELD RD., RALEIGH, NC, 27614, US

(21) Appl. No.: 12/113,631

(22) Filed: May 1, 2008

(51) Int. Cl. H04N 7/18

(52) U.S. Cl. 348/148; 348/E07.085

(57) ABSTRACT

The present invention relates to a personal vehicle surveillance system comprising cameras and microphones positioned such that they can record the type of events that happen to individuals rather than governmental vehicles. In addition, it provides for secure recording of events such that they are tamper resistant and can then be used during situations of problems with the vehicle or around the vehicle.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a personal motor vehicle surveillance system. In particular it relates to a system for protecting a personal motor vehicle and its occupants by providing multiple video and audio inside and outside the car with a tamper proof recording of the events so that they cannot easily be changed.

2. Description of Related Art

Incidents of a disputed nature between the occupants of personal motor vehicles such as cars, trucks, motor homes and the like and others such as occur in traffic accidents, law enforcement stops, random violence and the like have been ever increasing. One of the most difficult issues occurs during a vehicle stop by law enforcement agencies where acts of violence by the police have occasionally been reported and often disputed when the law enforcement agency is the perpetrator of the violence. Likewise during accidents, interactions between vehicle occupants and vehicle occupants from other vehicles or on the street and the like frequently, by the time they end up in court result in wildly different accounts of the facts that happened for a particular event.

More and more law enforcement vehicles carry video recorders that are being used to record a whole working shift for the law enforcement individual and are removable at the end of the day for downloading. These systems though usually assume that the action will always be in front of them or possibly to the sides. In addition the systems are easily erased, altered or stolen because of their easy access and need to download 8, 10 or 12 hours of video every shift. Accordingly, when the law enforcement is at fault, it is frequent that videos go missing or the violence occurs out of the range of the law enforcement video set up. Likewise, where there is an accident or event in the back of the vehicle, the police systems are inadequate.

Many recording systems have been developed which record events based on different criteria and wide variety of goals. In U.S. Pat. No. 6,524,020 issued Feb. 25, 2003 and issued to Ellinger et al there is disclosed a camera arranged on the superstructure of a vehicle. The camera can be folded away and is primarily intended for inclusion in racing vehicles although other instillations are contemplated.

In U.S. Pat. No. 7,272,179 issued Sep. 18, 2007 there is disclosed a camera system for placement in patrol cars that includes 2 video cameras, 4 audio sources and a long play recorder, which is easily removed at the end of a long shift to download the entire shift recording. In U.S. patent application No. 2003/0025599 published Feb. 6, 2003 to Monroe, there is disclosed a method for identifying the occurrence of an event at a remote location, prioritizing the event and then based on the priority forwarding the event to selected stations on a network and incorporating a scheme for tagging the event. None of these devices and systems however teaches the need for securing the recording device or recording media since the recorder is under the control of law enforcement, and it is assumed that tampering and destruction is not an issue. Rather, they focus on ease of removing recordings and sharing the recordings without concern for the recordings safety.

As can be readily seen, a wide variety of differing systems have been initiated and often patented each with a specific goal in terms of what the video recording system achieves. While there is this myriad of systems designed for law enforcement, commercial transportation and the like, currently, there is no system which meets the needs of the private user of a motor vehicle in providing a means for recording events for the personal vehicle user that meets the individual needs of such recordings such as but not limited to recording to a secure media, recording in all directions and not just forwards or backwards in a vehicle and on the inside as well, having the ability to secure the recording from overwriting or erasure and the like.

### BRIEF SUMMARY OF THE INVENTION

The present invention relates to a personal vehicle surveillance system that overcomes many of the limitations of the previous surveillance systems and designs it in such a way that it is useful in a personal vehicle, not in a law enforcement or other public vehicle. By positioning cameras and microphones 360 degrees and inside the vehicle and enclosing the recording and or transmitting device inside a tamper resistant enclosure and providing battery back up, the device can be safe from tampering and run even if the car is not or the regular battery is disconnected.

Accordingly, an embodiment of the present invention relates to surveillance system for use in a personal motor vehicle comprising:

a) two or more digital video cameras positioned sufficient to produce a 360 degree outside and vehicle internal video signal;

b) microphones sufficient to record inside the vehicle and in the area around the outside of the vehicle and produce an audio signal; and

c) a recording device having a digital storage capacity for recording the video signal and audio signal wherein the recording device comprises:
i. a tamper resistant recording device container for containing the recording device and fixedly mounting in the vehicle;
ii. a battery back-up; and

iii. the ability to prevent erasure or record-over upon the occurrence of a selected event;

The present invention further provides a method of providing a security surveillance system in a personal motor vehicle comprising:

a) positioning a plurality of digital video cameras on the outside and inside of the vehicle such that they essentially are capable of capturing a 360 degree outside view around the vehicle and a passenger compartment inside view inside the vehicle;

b) positioning a plurality of microphones inside and outside the vehicle capable of capturing the audio corresponding to the video view of a);

c) placing a digital recording medium in a tamperproof container in the vehicle and in recording communication with the cameras and microphones;

d) installing a means to prevent the erasure or recording over of the digital recording media upon the occurrence of a selected event.

### BRIEF DESCRIPTION OF THE DRAWINGS

FIG. 1 is a top view of a personal auto with cameras and microphones installed on the roof and inside the vehicle.

FIG. 2 is a side view of a personal auto showing the top side cameras with a cut out view showing the digital recorder and battery backup.

FIG. 3 shows the system of the present invention laid out without the motor vehicle.

FIG. 4 shows the recording device, transmitter and battery backup encased in tamper resistant containers.

### DETAILED DESCRIPTION OF THE INVENTION

The present invention relates to a system and method for providing surveillance security for personal vehicles which overcomes the problems and limitations of previous designs especially those designed for law enforcement and commercial use. In particular the invention solves these and other problems by positioning outside 360 degree camera coverage as well as inside camera and sound coverage and recording the view and sound to a tamper resistant digital recording medium with its own battery backup and optional internet transmission. The system allows for preventing any recordings being erased, over recorded, stolen, tampered with or the like and is capable of continuing to record in situations where the car has stopped and or the battery is disconnected, as might occur in an accident.

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one as or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “and an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

As used herein the phrase “surveillance system for use in a personal motor vehicle” refers firstly to a system of cameras (black and white or color as desired) and microphones designed for capturing video and sound during particular events which can happen in a personal vehicle as opposed to events in a governmental vehicle or law enforcement vehicle. Such events include stops by law enforcement, accidents, altercations with pedestrians or people in other vehicles, the theft of the vehicle and the like. This is in contrast to surveillance in a government or law enforcement vehicle which

The positioning of cameras in the present invention is much different than in a law enforcement vehicle. In the present invention at least 2 external cameras (for example, 2 fish eye lens cameras) are positioned such that together they comprise a view of 360 degrees around the vehicle. This way the system can view everything from accidents from the rear, altercations between vehicle occupants and others, which occur outside the vehicle; for example, after a traffic stop and the driver or passenger emerges from the vehicle and the like. In one embodiment there are 3 outside cameras, and in yet another embodiment, there are 4 outside cameras. The cameras can be positioned in any convenient location in the frame or on the car; for example, on the roof (as shown in one embodiment in the drawings), in the side framing of the vehicle, in the paneling of the vehicle, in vehicle molding or bumpers, on the windows and the like. In one embodiment the video cameras are mounted within the frame of the vehicle making it difficult to remove or destroy the cameras without severely damaging the frame, thus increasing the likelihood that the cameras cannot be disabled; for example, by someone who did not wish the events about to unfold to be recorded. Pin hole type cameras might be one embodiment of these type of cameras but in general, digital cameras of all types can be used in the implementation of the invention, and the system can be included in the vehicle as it is built or added on as an aftermarket system for vehicle surveillance. At least one camera will be positioned, in addition, to view the vehicle interior as needed so that any altercation or event inside the vehicle can also be recorded. That way anything happening right before an occupant leaves the vehicle or that happens in the vehicle is also covered in toto by the system.

Cameras of the present invention can also be equipped with additional features that make a personal surveillance system useful. The cameras can have manual or motorized movement capability such that they can pan and tilt in a desired direction. In addition, they can also have a lens with zoom capabilities. In addition, the cameras can be of the type that automatically follows movement and then auto focuses on the movement. By having cameras with automatic movement capabilities including zoom and focus, it is possible to have 360 degree coverage with fewer cameras that would otherwise be the case with static video cameras.

A minimum of one microphone outside the vehicle and one inside are necessary in order to record the audio from the video cameras placed in the vehicle in the system. There can be as many as necessary and stereo, mono or the like can be used with stereo, giving an additional advantage of sound direction when listened to while viewing the video. Likewise, positioning of the microphones can be anywhere but so that all 360 outside and inside sounds are recorded and in a position that it is difficult (tamper resistant) for someone to deactivate the microphones. In one embodiment a microphone is built into each video camera or associated with each camera so that sound and video can be matched based on recording from the same location on the car.

The system also needs a recording device for recording the audio and video in a digital manner when received signal comes from the cameras and microphones. By recording device, multiple devices could be used including multiple devices which can be each devoted to a single camera or multiple devices which each record the same thing so in the event one is destroyed or disabled another can still record. In one embodiment a single recording device can record the output of all the cameras and microphones in the system; for example, as done in store surveillance video systems where one screen shows all the cameras and audio involved. The device would be of the type that continuously records and when desired and the content of the digital recording media is full, to be erased or recorded over when what is on the device is not needed, i.e. when an event has not occurred.

The recording device must be in a tamper resistant container and be fixedly mounted to the vehicle. This prevents someone from taking or damaging the recording device in an attempt to destroy or prevent an event from being recorded. The tamper resistant container can be a part of the vehicle; for example, within the frame of the vehicle or can be a container specifically designed to contain the recording device and be tamper resistant because of its design, materials or both. Metal or plastic type containers are specific examples of materials but tamper resistant containers are well within the skill in the art. Likewise, one armed with the present disclosure could easily without undue experimentation find the best and safest location on a particular vehicle to protect it from being damaged or taken off the vehicle for purposes of tampering.

Since during an accident or during a tampering event the main vehicle battery could be taken out, disabled or damaged and the like, it is important that at least one battery backup be installed so that the system may continue to operate for a time even if the automobile is off and or the main vehicle battery is disconnected or not operating. The battery in one embodiment is inside the tamper resistant recording container or could be inside its own tamper resistant container. Likewise, the battery could be placed in the frame or other location in the vehicle making removal or damage extremely difficult without taking the car apart or otherwise damaging the vehicle, both of which take more time and effort than are reasonable during an “event”.

Yet another feature of the present invention is the ability of the recording device either manually or via an automatic means to engage a means for preventing further erasure or record-over of information on the device. Upon the occurrence of a particular event the ability to erase or record over would be disabled thus preventing the vital recording of the desired event from occurring accidently or because someone did not wish the evidence contained thereon to be seen.

While not wishing to be limited to this list, examples of events which are to be initiating the non erasure or record over feature would include a manually activated switch, the engagement of the vehicle air bags, the tripping of an optionally included vehicle burglar alarm system, a sensor which indicated that the vehicle has been in an accident (for example connected to the bumper), a sensor which indicates that the vehicle is being started by other that the corresponding vehicle key, or the engagement of some other recorder security system.

Other embodiments of the present invention include sending the audio and or video signals by wireless means to the recording device in order to prevent the possibility of cutting video or audio wires and further prevent tampering. If a wireless means is used, then the audio and video signals can be also sent to the internet or other location for distribution as desired. So, for example, the signal could be sent to the internet and picked up by personal devices such as the home computer or cell phone. This could be an automatic process or the user of the system could remotely activate the wireless system just to check on the status of the vehicle. Wireless means would allow a backup recording or personal recordings or pictures of particular events from any location that the user has access to the internet. In addition, where the cameras have auto adjust functions such as movement or zoom, those features could then be accessed remotely from the computer or cell phone. Remote functions could be very useful during an auto theft so that activities could be monitored and focused and followed on during the commission of a crime with the personal vehicle. Another embodiment of the remote option of the present invention is the ability to use the audio and video as a personal intercom system. One could have a conversation with someone receiving the signal or one could contact the vehicle using the present invention.

Another embodiment of the present invention would be to position a backup camera and or audio recording device which would be activated in the event that for some reason the original cameras or microphones malfunctions, breaks or is removed or disabled.

Another embodiment includes a means for downloading the information on the digital recording media without opening or disturbing the tamper resistant nature of the system. This could be done by including a recording port or a wireless means of downloading information.

Another embodiment of the present invention involves the system being able to download the audio and video signal from the recorder (or directly from the cameras and microphones) to the internet. From there the recordings could be recorded on a server preventing their erasure or recorded over at the vehicle and providing a permanent copy of the recorded event. This would be done by a wireless means but could also be done by a non wireless means; for example, by a USB connection to a computer having an internet connection. Since a vehicle may not have an internet connection available, the recording device in the vehicle becomes the primary method of insuring that the event is captured and preserved.

Because the nature of events which occur with private vehicles is different from law enforcement vehicles it may be necessary to allow the device to continuously record regardless of the car running or if the vehicle is occupied or not. That way if the vehicle is in the process of being stolen, the recording would capture the event. Likewise, if an altercation occurred by the car that didn't involve the passengers of the vehicle it could still be recorded. So, for example, where a robbery took place next to a vehicle or the car next to the system equipped vehicle is stolen, the system would record the event if within the scope of the vehicles cameras and microphones.

This system overcomes the lack of features that are used by law enforcement and systems; for example, on airplanes and the like which are intended for the protection of the vehicle or officer only and not for the general public in terms of all possible events.

In yet other embodiments, the use of GPS type devices in combination with the present invention can aid the user of the present system. GPS locators could, for example, be placed in one or more of the system components so that their removal or theft could be monitored.

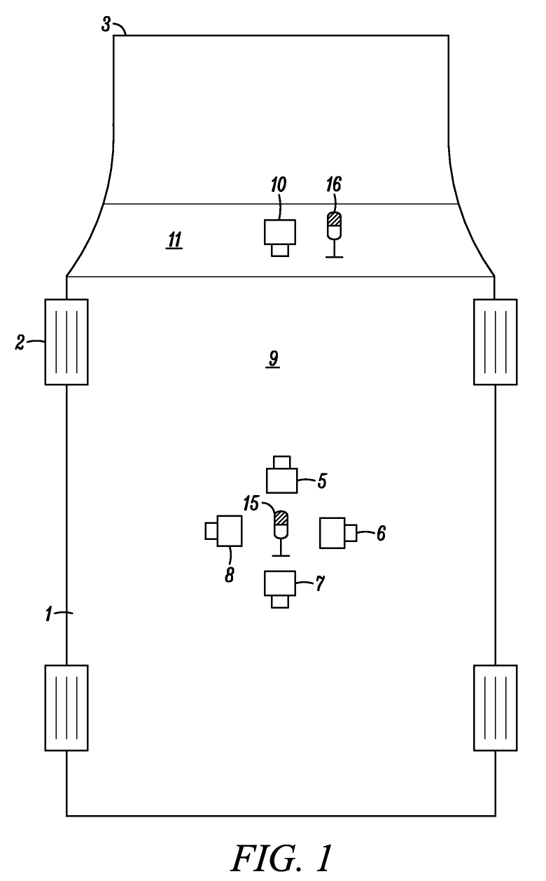

Now turning to the drawings, FIG. 1 is an embodiment of the present invention displaying the top view of personal auto 1. The drawings show the general outline of the auto 1 along with tires 2 and indicating the front of the vehicle 3. Four outside cameras, 5, 6, 7 and 8 are positioned in this view on top of auto 1, in this view on the roof 9. Since each of cameras 5, 6, 7 and 8 are placed at right angles to each other, they will, if their recording angle is at least 45 degrees, essentially record everything around the vehicle. The cameras could be placed closer to the roof 9 edge or in the roof 9, but the positioning for a 360 view is the main thrust of this embodiment view. Camera 10 is positioned inside the vehicle 1 on dash 11 which could be seen in this view through a windshield (left out for simplicity). Camera 10 could be used to record all of the interior of the vehicle; for example, by use of a fish eye or other wide angle lens and could be protected by actual installation into the dash itself and on dash 11, as depicted in the drawings.

Also shown in FIG. 1 is outside microphone 15 and inside microphone 16. With a microphone positioned outside and inside vehicle 1, one is assured of sound corresponding to the four outside cameras and one interior camera.

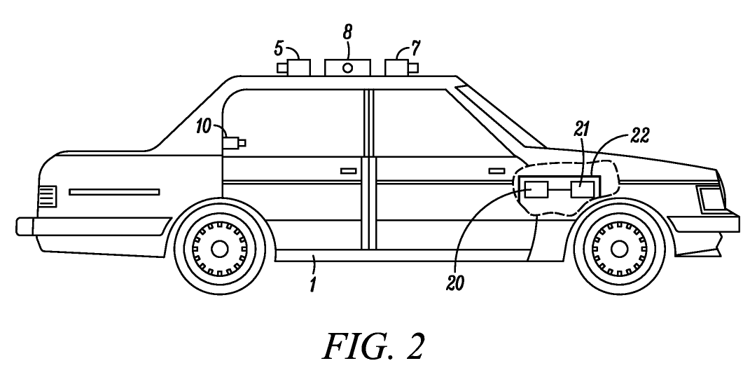

FIG. 2 depicts a side view of vehicle 1 with the same camera set up as FIG. 1; however, a cut out depicts the placement of the recording device 20 with battery backup 21. The two of them are enclosed in tamper resistant box 22, and everything is hidden in the frame area near the trunk and back seat of the vehicle making tampering difficult. Wires are run through the frame or in some embodiments sent wirelessly to the recording device.

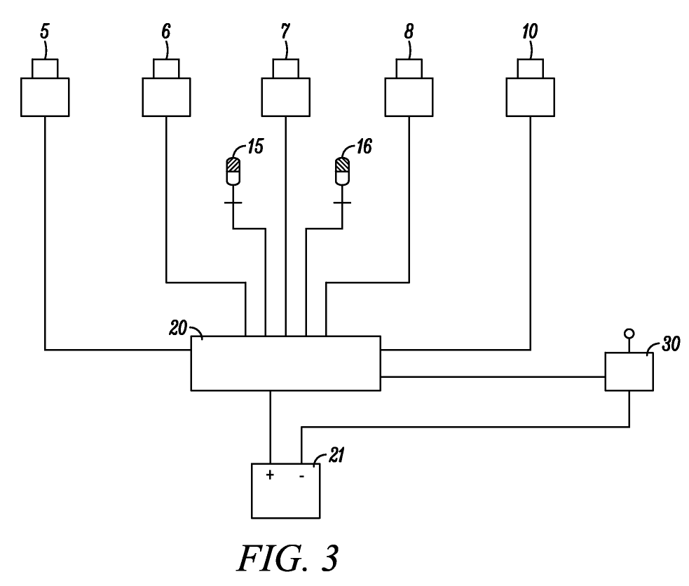

FIG. 3 depicts the wiring layout of an embodiment of the present system. Depicted are the cameras and microphones from FIG. 1. Also, the battery 21 and recording device 20 are shown. In this embodiment however the internet means for sending the audio and video to the internet is shown as internet device 30. This device can optionally send the recorded information to permanent storage or just for the purpose of viewing the information. This device could be manually operated or could be programmed to activate in the situation where one of the above described events occurs.

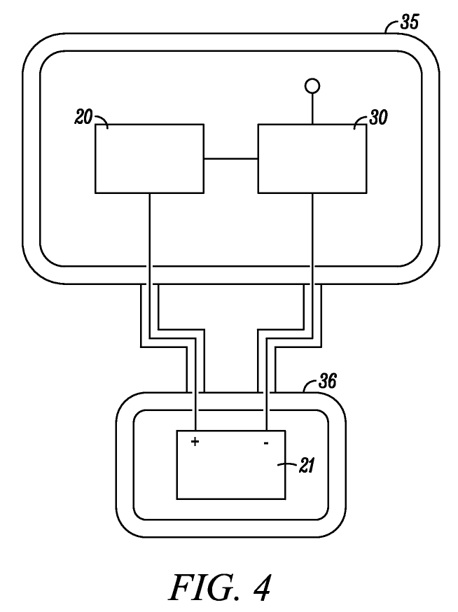

FIG. 4 depicts the layout of the recording device 20, an internet transmitter 30 and backup battery 21. In this embodiment, the recording device and transmitter 30 are encased in tamper resistant case 35, and the battery 21 in separate case 36, which is also tamper resistant. One skilled in the art could place all the devices together or separate as necessary or desired, based on the available space to place the devices, as well as their size and the need to separate each component.

One skilled in the art could easily make changes in the placement and number of cameras and microphones, the tamper resistant means and the like within the scope of the present invention, and the claims which follow should be so broadly interpreted.

What is claimed is:

1. A surveillance system for use in a personal motor vehicle comprising:
a) two or more digital video cameras positioned sufficient to produce a 360 degree outside and vehicle internal video signal;
b) one or more microphones sufficient to record inside the vehicle and in the area around the outside of the vehicle and produce an audio signal; and
c) a recording device having a digital storage capacity for recording the video signal and audio signal wherein the recording device comprises:
i. a tamper resistant recording device container for containing the recording device and fixedly mounting in the vehicle;
ii. a battery back-up; and
iii. the ability to prevent erasure or record-over upon the occurrence of a selected event;

2. A system according to claim 1 wherein the battery backup is tamper resistant.

3. A system according to claim 1 wherein the selected event is selected from the group comprising:
a) a manually activated switch;
b) the engagement of the vehicle air bags;
c) the tripping of a vehicle alarm system;
d) a sensor which indicates the vehicle has been in an accident;
e) starting the vehicle by means other than with a corresponding vehicle key; and
f) the engagement of a recorder security system.

4. A system according to claim 1 which further includes a means sending the video and audio signal by wireless means to a wireless receiver.

5. A system according to claim 4 wherein the wireless signal is sent to the internet to be received by computer or cell phone having internet access.

6. A system according to claim 1 which further comprises a means for downloading the contents of the digital storage media without compromising the tamper resistant nature of the tamper resistant container.

7. A system according to claim 1 wherein the recording device continuously records.

8. A system according to claim 1 wherein the recording device records only while the car is running.

9. A system according to claim 1 wherein the recording device is selectably capable of recording when the vehicle is running or not recording when the vehicle is running.

10. A system according to claim 9 wherein upon the occurrence of the selected event the recording device will continue to record regardless of whether the vehicle is running or not.

11. A system according to claim 1 wherein at least one of the cameras is capable of performing motorized functions.

12. A system according to claim 11 wherein the motorized functions are controllable from a remote site.

13. A system according to claim 1 which further comprises an intercom function.

14. A system according to claim 1 which further comprises at least one device in the system having a GPS tracking system.

15. A method of providing a security surveillance system in a personal motor vehicle comprising:
a) positioning a plurality of digital video cameras on the outside and inside of the vehicle such that they essentially are capable of capturing essentially a 360 degree outside view around the vehicle and a passenger compartment inside view inside the vehicle;
b) positioning a plurality of microphones inside and outside the vehicle capable of capturing the audio corresponding to the video view of a);
c) placing a digital recording medium in a tamperproof container in the vehicle and in recording communication with the cameras and microphones;
d) installing a means to prevent the erasure or recording over of the digital recording media upon the occurrence of a selected event.

16. A method according to claim 15 which further comprises sending the video and audio recorded by the digital recording medium to the internet via a wireless means.

17. A method according to claim 15 which further comprises installing a battery backup for the recording medium.

18. A method according to claim 15 which further comprises a wireless means for transmitting at least one of an image from the camera or audio from a microphone to a desired location.

19. A method according to claim 15 which further comprises a GPS tracking means.

20. A method according to claim 15 which further comprises an intercom function.

21. A method according to claim 15 which further comprises a means of accessing the surveillance system from an offsite location.
